(19) United States
(12) Patent Application Publication
(10) Pub. No.: US 2005/0024317 A1
(43) Pub. Date: Feb. 3, 2005

(54) Display device

(75) Inventor: Keiichi Sano, Taipei (TW)

Correspondence Address: MORRISON & FOERSTER LLP, 1650 TYSONS BOULEVARD, SUITE 300, MCLEAN, VA, 22102, US

(73) Assignee: Sanyo Electric Co., Ltd., Moriguchi-shi (JP)

(21) Appl. No.: 10/868,345

(22) Filed: Jun. 16, 2004

(30) Foreign Application Priority Data
Jun. 23, 2003 (JP) 2003-177517

(51) Int. Cl. G09G 3/36

(52) U.S. Cl. 345/100

(57) ABSTRACT

The invention is directed to simplification of a structure of a drive circuit disposed on a periphery of a pixel region to reduce a frame area of a display panel and power consumption. In a pixel, a TFT (T1), a TFT (T2), and a TFT (T3) are serially connected. The TFT (T1) is connected with a drain signal line DL1, and the TFT (T3) is connected with a pixel electrode of a liquid crystal. A first terminal of each of the first capacitor and the second capacitor is applied with ground potential (0V). A second terminal of the first capacitor is connected with a connection point of the TFT (T1) and the TFT (T2). A second terminal of the second capacitor is connected with a connection point of the TFT (T2) and the TFT (T3). Gates of the TFT (T1), the TFT (T2), and the TFT (T3) are respectively applied with control pulse signals A, B, and C for controlling on and off of these TFTs.

### BACKGROUND OF THE INVENTION

1. Field of the Invention

The invention relates to a display device, particularly having a DA converter converting a digital display signal into an analog display signal.

2. Description of the Related Art

In recent yeas, a portable display device, for example, a portable television or a cellular phone has been needed in the market. Research and development are pursued in downsizing, weight-reducing, and reducing of power consumption for the display device according to the needs.

FIG. 9 shows a circuit diagram of a pixel of a liquid crystal display device of a conventional art. In this liquid crystal display device, a plurality of pixels is disposed in a matrix of rows and columns to form a pixel region. A gate signal line 10 and a drain signal line 11 are formed on an insulating substrate (not shown), crossing each other. A pixel selecting thin film transistor 12 connected with the signal lines 10 and 11 is provided near the cross section of both the signal lines 10 and 11. A thin film transistor has a structure of a MOS transistor, and referred to as “TFT” hereafter. A source 12s of the pixel selecting TFT 12 is connected with a pixel electrode 14 of a liquid crystal 13.

A storage capacitor 15 for holding voltage of the pixel electrode 14 for a field is provided. One terminal 16 of the storage capacitor 15 is connected with the source 12s of the pixel selecting TFT 12, and common electric potential Vcom, which is common to the pixels, is applied to a common electrode 17.

When a scan signal (high level) is applied to the gate signal line 10, the pixel selecting TFT 12 turns on, and an analog display signal is supplied from the drain signal line 11 to the pixel electrode 14 to be held in the storage capacitor 15. The scan signal and the analog display signal are supplied from a drive circuit disposed on a periphery of the pixel region.

The analog display signal applied to the pixel electrode 14 is applied to the liquid crystal 13, and the liquid crystal 13 is aligned in accordance with the voltage of the analog display signal, thereby enabling liquid crystal display.

The analog display signal to be inputted to the drain signal line 11 is obtained by converting a digital display signal inputted from an external device into an analog display signal by a DA converter. Conventionally, the DA converter is disposed in the drive circuit disposed on the periphery of the pixel region.

FIG. 10 is a circuit diagram showing an example of such a DA converter. The four-bit digital display signal D0, D1, D2, D3 is supplied to four weighted capacitors C, C/2, C/4, C/8 through switches SW1, SW2, SW3, and SW4. Here, the D3 is most significant bit data, and the D0 is least significant bit data. Each of the bit data corresponds to 0 or 1.

Electric charge stored in each of the capacitors are added through the switches SW5, SW6, SW7, and SW8 so that voltage having sixteen gray scale voltages (V0 (D3+D2/2+D1/4+D0/8) can be obtained as the analog display signal. Here, V0 corresponds to amplitude voltage of the digital display signal. This analog display signal is amplified by an amplifier 50, and then outputted to the drain signal line 11.

FIG. 11 is a circuit diagram showing another example of the DA converter. Reference voltages Vref1 to Vref5 are inputted to the DA converter, and the switches SW1 to SW8 are switched based on control signals from a controller 51 according to a digital display signal D0, D1, D2, D3. Then, any two reference voltages among the reference voltages Vref1 to Vref5 are selected and supplied as two end voltages V1 and V2 of series resistors R1, R2, R3, and R4.

Voltages divided by resistances of the series resistors R1, R2, R3, and R4 are selected through the switches SW9 to SW12 so that sixteen gray scale voltages can be obtained. These gray scale voltages are outputted to the drain signal line 11 as the analog display signal. The switches SW1 to SW12 include the TFTs. Such a technology is disclosed in the Japanese Patent Application Publication No. Hei 10-848317.

However, the DA converter in FIG. 10 needs the amplifier 50, thereby increasing power consumption. Furthermore, if the amplifier 50 includes a low-temperature polysilicon TFT, the characteristic variation increases, leading to output differences between display panels.

Furthermore, in the DA converter in FIG. 11, for charging the drain signal line 11 enough, it is necessary to upsize the TFTs of the switches SW1 to SW12. This increases an area of the drive circuit, and makes it difficult to realize reduction of a frame size of the display panel, which has been required in recent years.

### SUMMARY OF THE INVENTION

The invention is directed to a display device realizing reduction of a frame area and power consumption. A display device of the invention has a plurality of pixels, a DA converter which is provided in each of the pixels and converts a digital display signal having a plurality of bits and serially transferred into an analog display signal, and a pixel electrode provided in each of the pixels and supplied with the analog display signal.

The DA converter has first and second capacitors each applied with common voltage to a first terminal thereof, a first switch switching between application and non-application of the digital display signal to a second terminal of the first capacitor, and a second switch switching between connection and disconnection of the second terminal of the first capacitor and a second terminal of the second capacitor. The analog display signal is outputted from the second terminal of the second capacitor.

Furthermore, a display device of the invention has a plurality of pixels, a DA converter which is provided in each of the pixels and converts a digital display signal having a plurality of bits and serially transferred into an analog display signal, and a pixel electrode provided in each of the pixels and supplied with the analog display signal.

The DA converter has a first capacitor applied with the digital display signal to a first terminal thereof, a first switch switching between short-circuit and non-short-circuit of the first terminal and the second terminal of the first capacitor, a second capacitor applied with predetermined voltage to the first terminal thereof, and a second switch switching between connection and disconnection of the second terminal of the first capacitor and the second terminal of the second capacitor. The analog display signal is outputted from the second terminal of the second capacitor.

### BRIEF DESCRIPTION OF THE DRAWINGS

FIG. 1 is an equivalent circuit diagram showing a liquid crystal display device of a first embodiment of the invention.

FIG. 2 is a timing chart explaining operation of the liquid crystal display device of the first embodiment of the invention.

FIG. 3 is a timing chart explaining the operation of the liquid crystal display device of the first embodiment of the invention.

FIGS. 4A, 4B, 4C, 4D and 4E are equivalent circuit diagrams of a DA converter for explaining the operation of the liquid crystal display device of the first embodiment of the invention.

FIG. 5 is an equivalent circuit diagram showing a liquid crystal display device of a second embodiment of the invention.

FIG. 6 is a timing chart explaining operation of the liquid crystal display device of the second embodiment of the invention

FIG. 7 is a timing chart explaining the operation of the liquid crystal display device of the second embodiment of the invention.

FIGS. 8A, 8B, 8C, 8D and 8E are equivalent circuit diagrams of a DA converter for explaining the operation of the liquid crystal display device of the second embodiment of the invention.

FIG. 9 is a circuit diagram of a pixel of a liquid crystal display device of a conventional art.

FIG. 10 is a circuit diagram of a DA converter of the conventional art.

FIG. 11 is a circuit diagram of other DA converter of the conventional art.

### DESCRIPTION OF THE PREFERRED EMBODIMENTS

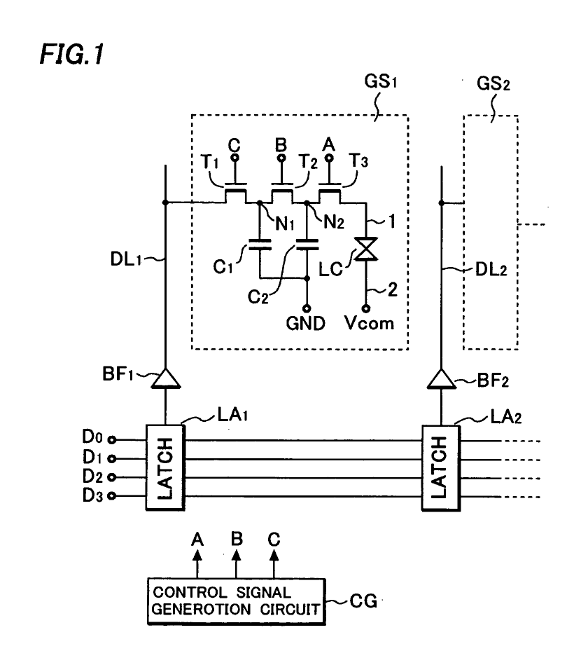

A display device of a first embodiment of the invention will be described with reference to the drawings. FIG. 1 is an equivalent circuit diagram of a liquid crystal display device. Although pixels are disposed in a matrix of m rows and n columns to form a pixel region, FIG. 1 shows a pixel GS1 and its adjacent pixel GS2 for simplification.

A four-bit digital display signal D0, D1, D2, D3 inputted from outside of the liquid crystal display device is latched in a latch circuit LA1 in a drive circuit, being synchronized with a latch clock, and converted into serial bit data to be outputted from the latch circuit LA1. The digital display signal D0, D1, D2, D3 outputted from the latch circuit LA1 as a serial signal is outputted to a drain signal line DL1 through a buffer BF1, and then inputted to the pixel GS1 at predetermined timing described below.

Furthermore, a digital display signal D0, D1, D2, D3 is latched at a latch circuit LA2 in a drive circuit, being synchronized with a next latch clock, and converted into serial bit data to be outputted from the latch circuit LA2. The digital display signal D0, D1, D2, D3 outputted from the latch circuit LA2 as a serial signal is outputted to a drain signal line DL2 through a buffer BF2, and then inputted to a pixel GS2 at predetermined timing.

If the four-bit digital display signal D0, D1, D2, D3 inputted from outside of the liquid crystal display device is a serial signal, the signal is supplied to each of the pixels GS1, GS2 and so on without parallel-to-serial conversion.

A structure of the pixel GS1 will be described next. The other pixels have the same structure as the pixel GS1. TFT(T1), TFT(T2), and TFT(T3) are serially connected. A drain of the TFT (T1) is connected with the drain signal line DL1, and a source of the TFT (T3) is connected with a pixel electrode 1 of a liquid crystal LC. Although the TFTs (T1), (T2), and (T3) are of N-channel type in this description, there is no limitation to this and the TFTs (T1), (T2), and (T3) can be of P-channel type.

Common electric potential Vcom, which is common to the pixels, is applied to a common electrode 2 of the liquid crystal LC. A first terminal of each of first and second capacitors C1 and C2 is applied with common electric potential, e.g. ground potential (0V). A second terminal of the first capacitor C1 is connected with a connection point N1 of the TFT (T1) and the TFT (T2). A second terminal of the second capacitor C2 is connected with a connection point N2 of the TFT (T2) and the TFT (T3).

The TFT (T1) is a switch for selectively supplying the digital display signal D0, D1, D2, D3 to the second terminal of the first capacitor C1. The TFT (T2) is a switch for selectively connecting the second terminal of the first capacitor C1 and the second terminal of the second capacitor C2.

Gates of the TFT (T1), TFT (T2), and TFT (T3) are applied with control pulse signals A, B, and C for controlling on and off of these TFTs, respectively. These control pulse signals A, B, and C are generated from a control signal generation circuit CG in the drive circuit.

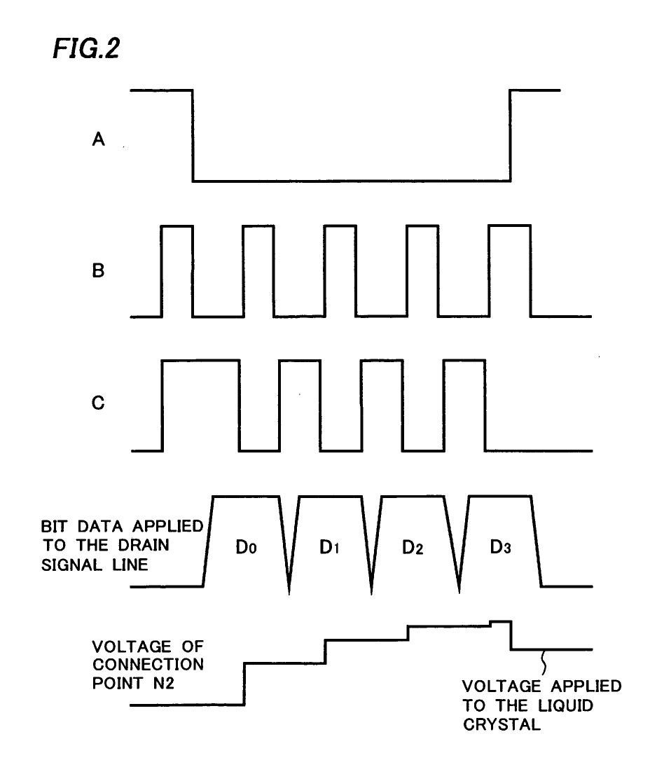

FIG. 2 is an operation timing chart of the liquid crystal display device of FIG. 1. When the control pulse signal A is at low level, the TFT (T3) is turning off. During this period, the digital display signal D0, D1, D2, D3 is taken in the pixel GS1 in this order, being synchronized with the control pulse signal C. Then, arithmetic processing, which will be described below, is performed in accordance with changes of the control pulse signals B and C, and DA (digital-to-analog) converted voltage V=V0(D3/2+D2/4+D1/8+D0/16) is applied to the connection point N2 of the TFTs (T2) and (T3). Here, V0 corresponds to voltage amplitude of the digital display signal.

When the control pulse signal A turns high, the TFT (T3) turns on so that the DA converted voltage at the connection point N2 is applied to the pixel electrode 1 of the liquid crystal LC through the TFT (T3). The DA converter thus includes the TFT (T1), the TFT (T2), the TFT (T3), the first capacitor C1, and the second capacitor C2 in the pixel GS1.

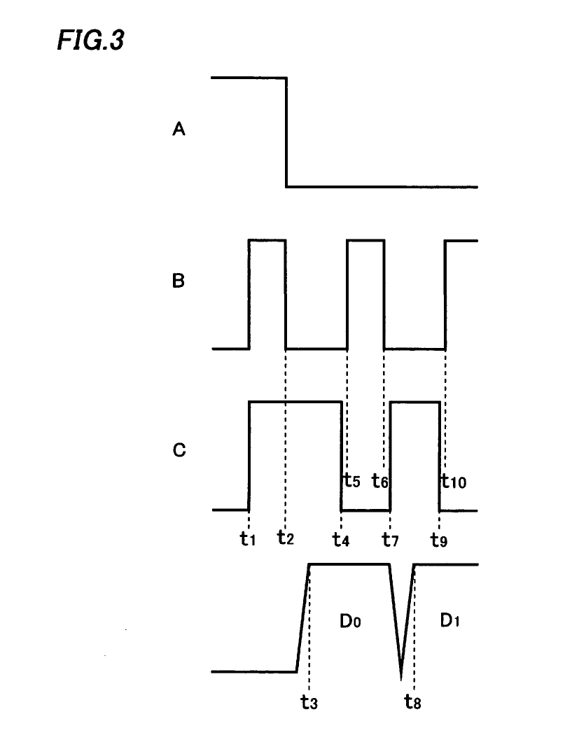

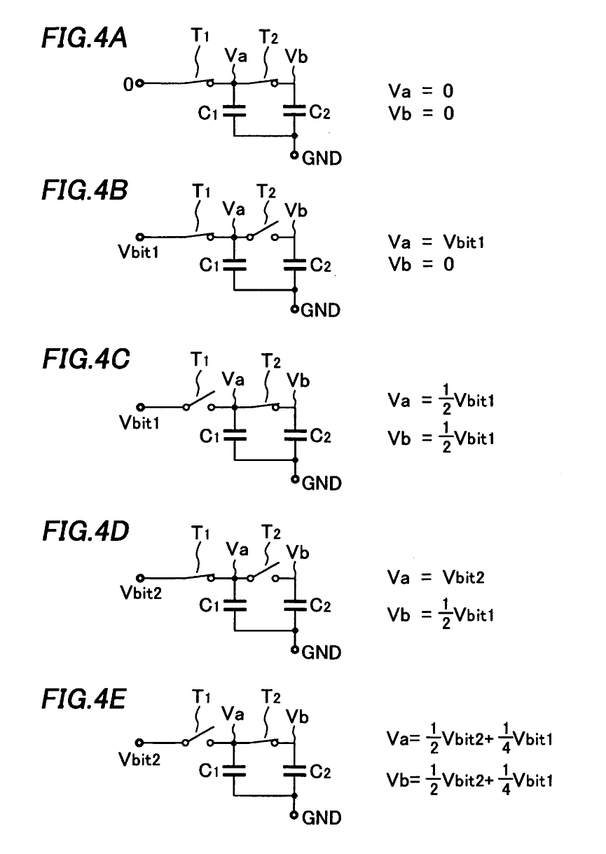

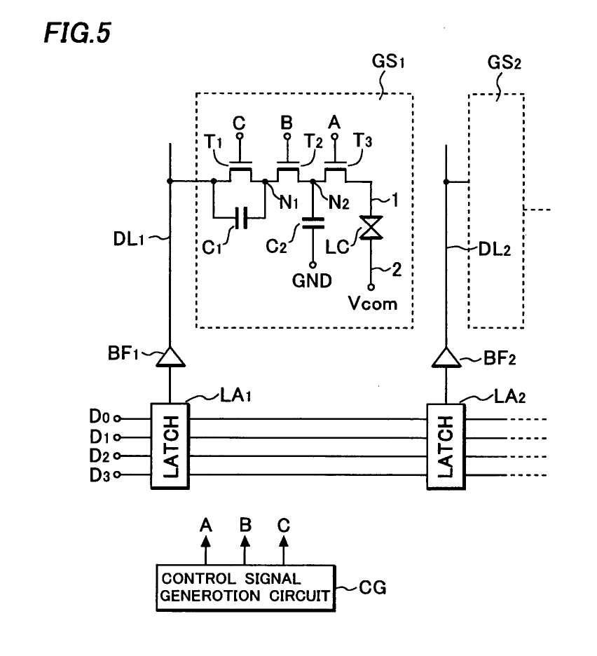

Next, the operation of this DA converter will be described with reference to FIGS. 3 and 4 in detail. FIG. 3 is an enlarged operation timing chart of FIG. 2, and FIGS. 4A, 4B, 4C, 4D and 4E are equivalent circuit diagrams of the DA converter, showing the TFT (T1) and the TFT (T2) by equivalent switches.

The voltage at a connection point of T1 and T2 is Va, and terminal voltage of the second capacitor C2 is Vb. Bit data voltage corresponding to the digital display signal D0, D1, D2, D3 is Vbit1, Vbit2, Vbit3, and Vbit4. Then, Vbit1=V0×D0, Vbit2=V0×D1, Vbit3=V0×D2, and Vbit4=V0×D3. V0 is amplitude voltage of the digital display signal D0, D1, D2, D3, and the digital display signal D0, D1, D2, D3 switches between 0V and V0. Furthermore, the first capacitor C1 and the second capacitor C2 have the same capacitance value.

When the control pulse signals B and C turn high at time t1, T1 and T2 turn on. At this time, when the digital display signal is 0V (data “0”), Va=Vb=0V. FIG. 4A shows this state.

When the control pulse signal B turns low at time t2 next, T2 turns off. Next, at time t3, the bit data voltage Vbit1 corresponding to the first-bit digital display signal D0 is applied to the terminal of the first capacitor C1 through T1. At this time, Va=Vbit1, and Vb=0V. FIG. 4B shows this state.

When the control pulse signal C turns low at time t4 next, T1 turns off. When the control pulse signal B turns high at time t5 next, T2 turns on. Then, the first capacitor C1 and the second capacitor C2 are connected with each other, a half of the electric charge stored in the first capacitor C1 is distributed to the second capacitor C2 so that Va=Vb=Vbit1/2. Arithmetic processing for halving the bit data voltage is thus performed. FIG. 4C shows this state.

Then, the above operation is repeated, that is, the T2 turns off when the control pulse signal B turns low at time t6, and T1 turns on when the control pulse signal C turns high at time t7 next. After that, the bit data voltage Vbit2 corresponding to the second-bit digital display signal D1 is applied to the terminal of the first capacitor C1 through T1 at time t8. Then, Va=Vbit2, and Vb=Vbit1/2. FIG. 4D shows this state.

When the control pulse signal C turns low at time t9 next, T1 turns off. When the control pulse signal B turns high at time t10 next, T2 turns on. Then, the first capacitor C1 and the second capacitor C2 are connected with each other. Therefore, arithmetic processing for halving the sum of Va and Vb is performed, so that Va=Vb=Vbit2/2+Vbit1/4. That is, arithmetic processing for halving voltage is performed. FIG. 4C shows this state.

By repeating this operation the DA conversion of the digital display signal D0, D1, D2, D3 is performed, and the result is that V=Vbit4/2+Vbit3/4+Vbit2/8+Vbit1/16. That is, the four-bit digital display signal D0, D1, D2, D3 is converted into sixteen gray scale voltages corresponding thereto.

Next, a display device of a second embodiment of the invention will be described with reference to the drawings. FIG. 5 is an equivalent circuit diagram of a liquid crystal display device. Pixels are disposed in a matrix of m rows and n columns. FIG. 5 shows a pixel GS1 and its adjacent pixel GS2 only for simplification.

Since a peripheral circuit of the pixel is the same as that of the first embodiment, a structure of the pixel GS1 will be described in this embodiment. Other pixels have the same structure as the pixel GS1. TFT(T1), TFT(T2), and TFT(T3) are serially connected. A drain of the TFT (T1) is connected with a drain signal line DL1, and a source of the TFT (T3) is connected with a pixel electrode 1 of a liquid crystal LC. Although the TFTs (T1), (T2), and (T3) are of N-channel type in this description, there is no limitation to this and the TFTs (T1), (T2), and (T3) can be of P-channel type. Common electric potential Vcom, which is common to the pixels, is applied to a common electrode 2 of the liquid crystal LC.

A first terminal of the first capacitor C1 is connected with the drain of the TFT (T1), and a second terminal of the first capacitor C1 is connected with a connection point N1 of the TFTs (T1) and (T2). A first terminal of the second capacitor C2 is applied with common electric potential, e.g. ground potential (0V), and a second terminal thereof is connected with a connection point N2 of the TFT (T2) and TFT (T3).

The TFT (T1) is a switch for selectively short-circuiting both terminals of the first capacitor C1, and the TFT (T2) is a switch for selectively connecting the second terminal of the first capacitor C1 and the second terminal of the second capacitor C2.

Gates of the TFT (T1), the TFT (T2), and the TFT (T3) are respectively applied with control pulse signals A, B, and C for controlling on and off of these TFTs. These control pulse signals A, B, and C are generated from a control signal generation circuit CG in a drive circuit.

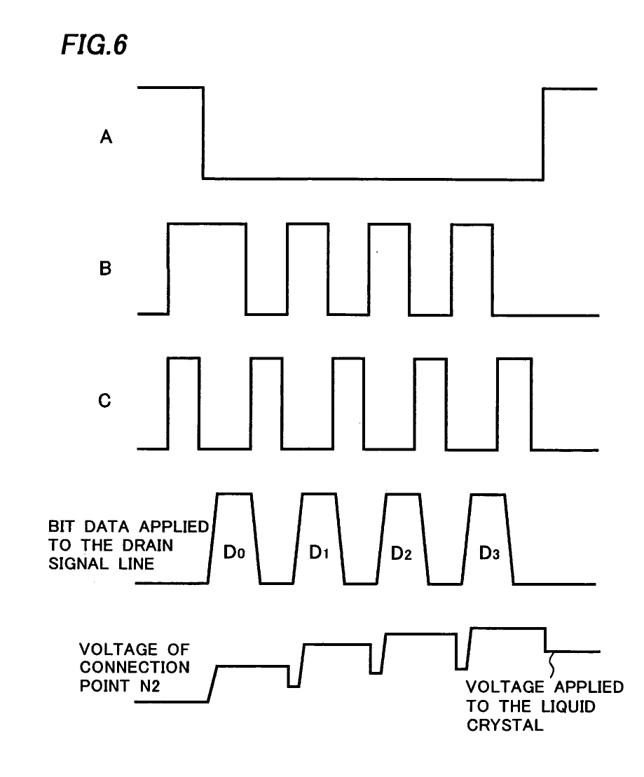

FIG. 6 is an operation timing chart of the liquid crystal display device of FIG. 5. When the control pulse signal A is at low level, the TFT (T3) is turning off. During this period, the digital display signal D0, D1, D2, D3 is taken in the pixel GS1 in this order, synchronized with the control pulse signal C. Then, arithmetic processing, which will be described below, is performed in accordance with changes of the control pulse signals B and C, and DA (digital-to-analog) converted voltage V=V0(D3/2+D2/4+D1/8+D0/16) is applied to the connection point N2 of the TFTs (T2) and (T3). Here, V0 corresponds to voltage amplitude of the digital display signal.

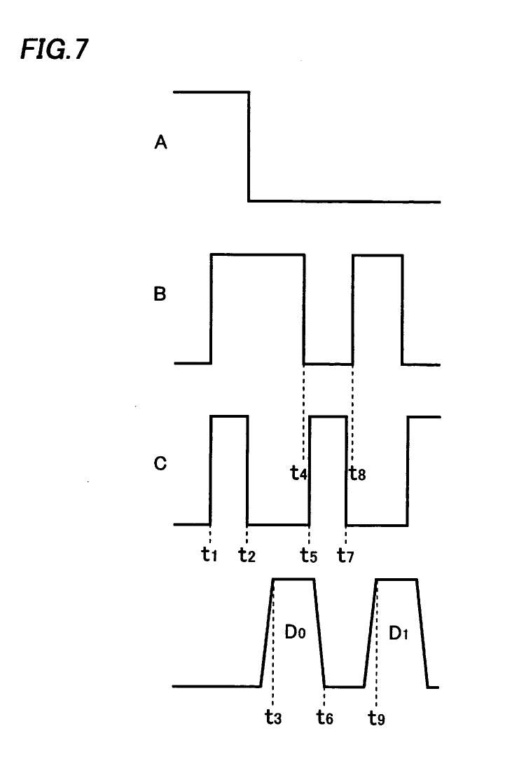

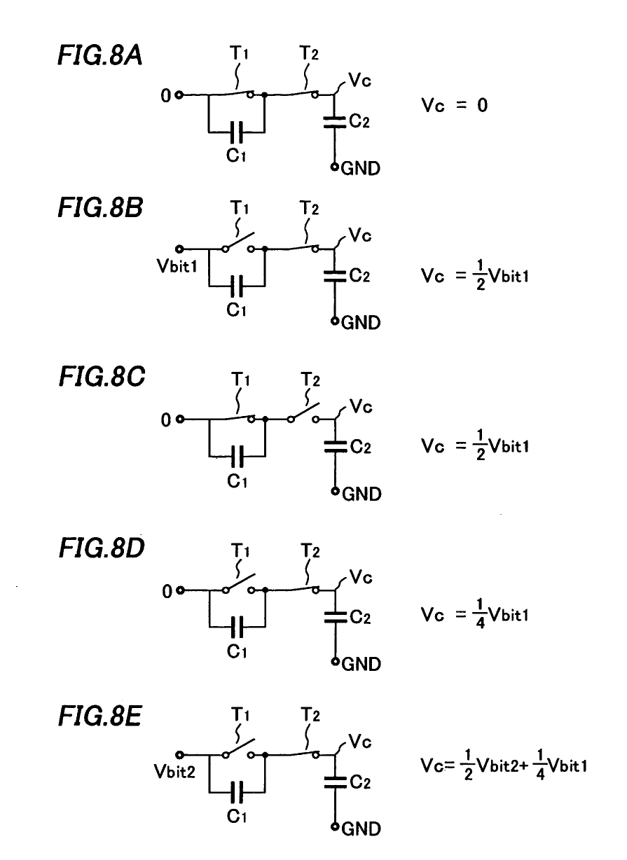

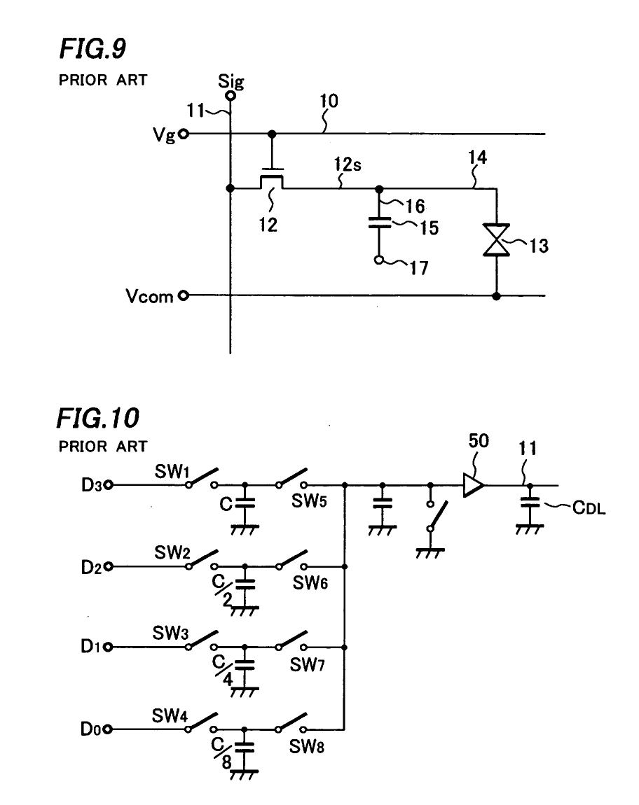

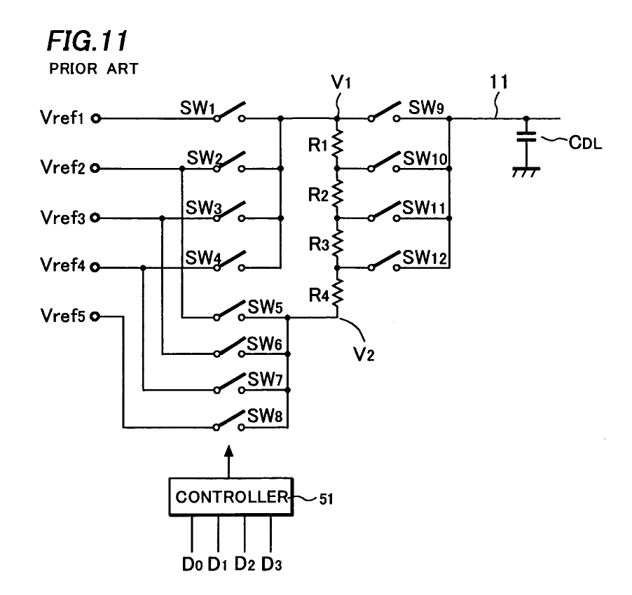

Next, the operation of this DA converter will be described with reference to FIGS. 7 and 8 in detail. FIG. 7 is an enlarged operation timing chart of FIG. 6, and FIGS. 8A, 8B, 8C, 8D, and 8E are equivalent circuit diagrams of the DA converter, showing the TFT (T1) and the TFT (T2) by equivalent switches.

Terminal voltage of the second capacitor C2 is Vc. Bit data voltage corresponding to the digital display signal D0, D1, D2, D3 is Vbit1, Vbit2, Vbit3, and Vbit4, as is the case with the first embodiment. Then, Vbit1=V0×D0, Vbit2=V0×D1, Vbit3=V0×D2, and Vbit4=V0×D3. V0 is amplitude voltage of the digital display signal D0, D1, D2, D3, and the digital display signal D0, D1, D2, D3 switches between 0V and V0. Furthermore, the first capacitor C1 and the second capacitor C2 have the same capacitance value.

When the control pulse signals B and C turn high at time t1, T1 and T2 turn on. Turning on of T1 makes the first terminal and the second terminal of the first capacitor C1 short-circuited. At this time, when the digital display signal is 0V (data “0”), Vc=0V. FIG. 8A shows this state.

When the control pulse signal C turns low at time t2 next, T1 turns off and the short circuit is cleared. Next, at time t3, the bit data voltage Vbit1 corresponding to the first-bit digital display signal D0 is applied to the first terminal of the first capacitor C1. At this time, Vc=Vbit1/2. FIG. 8B shows this state.

When the control pulse signal B turns low at time t4 next, T2 turns off. When the control pulse signal C turns high at time t5, T1 turns on. Then, the first terminal and the second terminal of the first capacitor C1 are short-circuited again. Furthermore, an outputting period of the digital display signal D0 is terminated at time t6, the signal lowers to 0V. This makes electric charge stored in the first capacitor C1 is discharged, and voltage of both the terminals becomes 0V. Since T2 is turning off, Vc=Vbit1/2. FIG. 8C shows this state.

When the control pulse signal C turns low at time t7 next, T1 turns off and the short circuit of the terminals is cleared. When the control pulse signal B turns high at time 8 next, T2 turns on and the first capacitor C1 and the second capacitor C2 are connected. Since a half of electric charge stored in the second capacitor C2 is distributed to the first capacitor C1, Vc=Vbit1/4. Arithmetic processing for halving voltage is thus performed. FIG. 8D shows this state.

Then, the above operation is repeated, that is, bit data voltage Vbit2 corresponding to the second-bit digital display signal D1 is applied to the first terminal of the first capacitor C1. Then, Vc=Vbit2/2+Vbit1/4. FIG. 8E shows this state.

By repeating this operation the DA conversion of the digital display signal D0, D1, D2, D3 is performed, and the result is that V=Vbit4/2+Vbit3/4+Vbit2/8+Vbit1/16, as is the case with the first embodiment. That is, the four-bit digital display signal D0, D1, D2, D3 is converted into sixteen gray scale voltages corresponding thereto.

Although the DA conversion of the four-bit digital display signal D0, D1, D2, D3 is described in the first and second embodiments as an example, these embodiments can be modified to convert a digital display signal having an arbitrary number of bits into an analog signal. Furthermore, although the liquid crystal display device is described in the first and second embodiments as an example, the invention can be applied to other display devices displaying by converting a digital display signal into an analog display signal, e.g., an electroluminescent display device.

1. A display device comprising a plurality of pixels, each of the pixels comprising:
a DA converter converting a digital display signal having a plurality of bits and serially transferred into an analog display signal;
a pixel electrode receiving the analog display signal;
a first capacitor and a second capacitor provided in the DA converter, a common electric potential being applied to a first terminal of each of the first and second capacitors;
a first switch provided in the DA converter and applying the digital display signal to a second terminal of the first capacitor in response to a first control signal; and
a second switch provided in the DA converter and connecting the second terminal of the first capacitor and a second terminal of the second capacitor in response to a second control signal,
wherein the analog display signal is outputted from the second terminal of the second capacitor to the pixel electrode.

2. The display device of claim 1, further comprising a control signal generation circuit outputting the first and second control signals so that the first switch turns on and the second switch turns off to apply to the second terminal of the first capacitor one of bit voltages of the digital display signal serially transferred, and the first switch turns off and the second switch turns on to connect the first and second capacitors for dividing the one of bit voltages between the two capacitors.

3. The display device of claim 1, further comprising a third switch supplying the analog display signal to the pixel electrode.

4. The display device of claim 1, wherein the first switch comprises a first MOS transistor receiving the first control signal at a gate thereof, and the second switch comprises a second MOS transistor receiving the second control signal at a gate thereof.

5. A display device comprising a plurality of pixels, each of the pixels comprising:
a DA converter converting a digital display signal having a plurality of bits and serially transferred into an analog display signal;
a pixel electrode receiving the analog display signal;
a first capacitor provided in the DA converter, the digital display signal being supplied to a first terminal of the first capacitor;
a first switch provided in the DA converter and short-circuiting the first terminal of the first capacitor and a second terminal of the first capacitor in response to a first control signal;
a second capacitor provided in the DA converter, a predetermined voltage being supplied to a first terminal of the second capacitor; and
a second switch provided in the DA converter and connecting the second terminal of the first capacitor and a second terminal of the second capacitor in response to a second control signal,
wherein the analog display signal is outputted from the second terminal of the second capacitor to the pixel electrode.

6. The display device of claim 5, further comprising a control signal generation circuit outputting the first and second control signals so that the first switch turns off and the second switch turns on to divide one of bit voltages of the digital display signal serially transferred between the first and second capacitors, the first switch turns on and the second switch turns off to maintain the divided bit voltage at the second capacitor and discharge the divided bit voltage at the first capacitor, and the first switch turns off and the second switch turns on to further divide the one of bit voltages of the digital display signal.

7. The display device of claim 5, further comprising a third switch supplying the analog display signal to the pixel electrode.
